(19) United States
(12) Patent Application Publication
(10) Pub. No.: US 2022/0049445 A1
(43) Pub. Date: Feb. 17, 2022

(54) FLOATING MATTER GUIDANCE CONTROL DEVICE, FLOATING MATTER GUIDANCE SYSTEM, AND FLOATING MATTER GUIDANCE CONTROL METHOD

(71) Applicant: MITSUBISHI ELECTRIC CORPORATION, Tokyo (JP)

(72) Inventors: Tai TANAKA, Tokyo (JP); Yasuo MORIMOTO, Tokyo (JP); Jin HIRANO, Tokyo (JP); Masaharu IMAKI, Tokyo (JP)

(73) Assignee: MITSUBISHI ELECTRIC CORPORATION, Tokyo (JP)

(21) Appl. No.: 17/462,267

(22) Filed: Aug. 31, 2021

Related U.S. Application Data
(63) Continuation of application No. PCT/JP2019/014991, filed on Apr. 4, 2019.

(51) Int. Cl. E02B 15/08; G05B 15/02; C02F 1/40; C02F 1/34; B06B 1/02

(52) U.S. Cl. CPC E02B 15/08; G05B 15/02; C02F 2103/007; C02F 1/34; B06B 1/0207; C02F 1/40

(57) ABSTRACT

A floating matter guidance control device includes a floating matter information obtaining unit for obtaining floating matter information about floating matter on a water surface; a vibration determining unit for determining a frequency of vibration generated by a vibration generating device for generating a water surface wave by vibrating a water surface, on the basis of the floating matter information obtained by the floating matter information obtaining unit; and a vibration generating device control unit for controlling the vibration generating device so that the vibration generating device vibrates at the frequency determined by the vibration determining unit.

### CROSS REFERENCE TO RELATED APPLICATIONS

This application is a Continuation of PCT International Application No. PCT/JP2019/014991, filed on Apr. 4, 2019, which is hereby expressly incorporated by reference into the present application.

### TECHNICAL FIELD

The present invention relates to floating matter guidance control device that controls a vibration generating device that generates a water surface wave.

### BACKGROUND ART

Floating matter on a water surface of a pond, a lake, a dam, a sea, or the like, is a big cause of water pollution. Examples of such floating matter include floating grass such as boodlea coacta, plastic products such as plastic bottles, oil, and pieces of wood. When floating matter such as the examples is left on a water surface of a pond, a lake, a dam, a sea, or the like, environmental deterioration is caused such as corrosion or deterioration of a hydroelectric power facility such as a water wheel, or extinction of creatures due to the lack of sunlight.

As one example of a method of collecting floating matter on a water surface such as that described above, there is a method of manually collecting floating matter. In the method, for example, a person manually collects floating matter using a landing net on a work boat. In addition, Patent Literature 1 describes a floating matter collection device that collects floating matter on a water surface. The floating matter collection device includes floating matter sucking means for sucking up floating matter on a water surface by disposing a downward suction port near the water surface.

### CITATION LIST

### Patent Literatures

Patent Literature 1: JP 2009-254940 A

### SUMMARY OF INVENTION

### Technical Problem

A method of manually collecting floating matter such as that described above has a problem that a person needs to be moved to a location near floating matter on a water surface. In addition, when the floating matter collection device described in Patent Literature 1 such as that described above is used, there is a problem that there is a need to move a suction port that sucks up floating matter on a water surface to a location near the floating matter on the water surface.

The invention is made to solve problems such as those described above, and an object of the invention is to provide a technique that enables collection of floating matter on a water surface without moving a person or a device to a location near the floating matter on the water surface.

### Solution to Problem

A floating matter guidance control device according to the invention includes: processing circuitry to obtain floating matter information about floating matter on a water surface; to determine a frequency of vibration generated by a vibration generating device to generate a water surface wave by vibrating a water surface, on a basis of the obtained floating matter information; and to control the vibration generating device so that the vibration generating device vibrates at the determined frequency.

### Advantageous Effects of Invention

According to the invention, floating matter on a water surface can be collected without moving a person or a device to a location near the floating matter on the water surface.

### BRIEF DESCRIPTION OF DRAWINGS

FIG. 1 is a block diagram showing a configuration of a floating matter guidance system including a floating matter guidance control device according to a first embodiment.

FIG. 2 is a schematic diagram showing a configuration of a vibration generating device included in the floating matter guidance system according to the first embodiment.

FIG. 3A is a block diagram showing a hardware configuration that implements the functions of the floating matter guidance control device according to the first embodiment, and FIG. 3B is a block diagram showing a hardware configuration that executes software that implements the functions of the floating matter guidance control device according to the first embodiment.

FIG. 4 is a flowchart showing a floating matter guidance control method performed by the floating matter guidance control device according to the first embodiment.

FIGS. 5A and 5B each are a schematic diagram for describing a first specific example of the floating matter guidance control method performed by the floating matter guidance control device according to the first embodiment.

FIGS. 6A, 6B, and 6C each are a schematic diagram for describing a second specific example of the floating matter guidance control method performed by the floating matter guidance control device according to the first embodiment.

FIGS. 7A and 7B each are a schematic diagram for describing a third specific example of the floating matter guidance control method performed by the floating matter guidance control device according to the first embodiment.

FIGS. 8A, 8B, and 8C each are a diagram for describing a comparative example of a case in which the floating matter guidance control device in the third specific example has not performed the floating matter guidance control method.

FIGS. 9A, 9B, and 9C each are a diagram for describing an implementation example of a case in which the floating matter guidance control device in the third specific example has performed the floating matter guidance control method.

FIG. 10 is a block diagram showing a configuration of a floating matter guidance system including a floating matter guidance control device according to a second embodiment.

FIG. 11A is a block diagram showing a hardware configuration that implements the functions of the floating matter guidance control device according to the second embodiment, and FIG. 11B is a block diagram showing a hardware configuration that executes software that implements the functions of the floating matter guidance control device according to the second embodiment.

FIG. 12 is a flowchart showing a measuring device guidance control method performed by the floating matter guidance control device according to the second embodiment.

FIG. 13 is a flowchart showing a floating matter guidance control method performed by the floating matter guidance control device according to the second embodiment.

FIG. 14 is a schematic diagram for describing a specific example of the measuring device guidance control method and the floating matter guidance control method which are performed by the floating matter guidance control device according to the second embodiment.

### DESCRIPTION OF EMBODIMENTS

To describe the invention in more detail, embodiments for carrying out the invention will be described below with reference to the accompanying drawings.

### First Embodiment

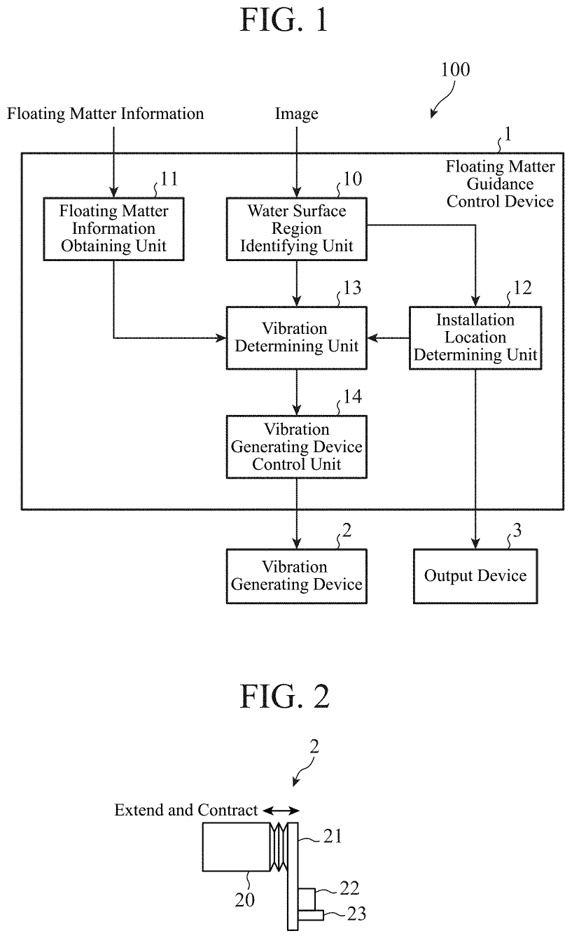

FIG. 1 is a block diagram showing a configuration of a floating matter guidance system 100 including a floating matter guidance control device 1 according to a first embodiment. As shown in FIG. 1, the floating matter guidance system 100 includes the floating matter guidance control device 1, a vibration generating device 2, and an output device 3. The floating matter guidance control device 1 includes a water surface region identifying unit 10, a floating matter information obtaining unit 11, an installation location determining unit 12, a vibration determining unit 13, and a vibration generating device control unit 14.

The water surface region identifying unit 10 identifies a region of a water surface. Examples of the water surface include a water surface of a pond, a water surface of a lake, a water surface of a dam, and a water surface of a sea. Examples of the region of a water surface include a region surrounded by a shore, a region from a coastline to a specific distance, and any region in a water surface.

The water surface region identifying unit 10, for example, obtains data representing a region of a water surface, and identifies the region of a water surface on the basis of the data. Examples of the data representing a region of a water surface include data of an image photographed from a satellite, data of an image photographed from the air, and map data.

In addition, when the data representing a region of a water surface is image data, the water surface region identifying unit 10 may further identify a location of floating matter on the basis of the image data.

Note that although the present embodiment describes a configuration in which the floating matter guidance control device 1 includes the water surface region identifying unit 10, a function of identifying a region of a water surface is not essential in the floating matter guidance control device 1, and the floating matter guidance control device 1 does not need to include the water surface region identifying unit 10. For example, when a water surface having floating matter thereon is a relatively large water surface of a sea, etc., the floating matter guidance control device 1 does not need to identify a region of the water surface.

The floating matter information obtaining unit 11 obtains floating matter information about floating matter on a water surface. Examples of floating matter information include the type of floating matter, the location of the floating matter, the size of the floating matter, and the mass of the floating matter. Examples of the type of floating matter include floating grass, plastic products, oil, and pieces of wood. For example, the floating matter information obtaining unit 11 obtains floating matter information which is inputted to the floating matter guidance control device 1 by a user through an input device which is not shown. In addition, when the floating matter guidance control device 1 obtains image data representing a region of a water surface, the floating matter information obtaining unit 11 may obtain floating matter information by analyzing the image data.

The installation location determining unit 12 determines an installation location of the vibration generating device 2 on the basis of the region of a water surface identified by the water surface region identifying unit 10. Examples of the installation location of the vibration generating device 2 which is determined by the installation location determining unit 12 include a shore, a beach, and a location on a water surface in a case in which the vibration generating device 2 is installed on a boat. The installation location determining unit 12 may determine an installation location of the vibration generating device 2 further on the basis of the floating matter information obtained by the floating matter information obtaining unit 11. For example, the installation location determining unit 12 may determine an installation location of the vibration generating device 2 further on the basis of a location of floating matter indicated by the floating matter information. Note that although the present embodiment describes a configuration in which the floating matter guidance control device 1 includes the installation location determining unit 12, a function of determining an installation location of the vibration generating device 2 is not essential in the floating matter guidance control device 1, and the floating matter guidance control device 1 does not need to include the installation location determining unit 12. In that case, for example, the vibration generating device 2 is installed at an installation location in advance, and the user inputs the installation location to the floating matter guidance control device 1.

The vibration determining unit 13 determines a frequency of vibration generated by the vibration generating device 2 that generates a water surface wave by vibrating a water surface, on the basis of the floating matter information obtained by the floating matter information obtaining unit 11. For example, when the floating matter information indicates a sponge as the type of floating matter, the vibration determining unit 13 determines a frequency of vibration generated by the vibration generating device 2 to be 100 Hz. In addition, when floating matter on a water surface has not been guided to a collection location by a water surface wave generated by the vibration generating device 2, the user may perform input to instruct the floating matter guidance control device 1 to change the frequency of vibration generated by the vibration generating device 2, and the vibration determining unit 13 may change the frequency of vibration generated by the vibration generating device 2, on the basis of the inputted instruction.

In addition, the vibration determining unit 13 may determine a frequency of vibration generated by the vibration generating device 2, further on the basis of the installation location of the vibration generating device 2 determined by the installation location determining unit 12 or the installation location at which the vibration generating device 2 is installed in advance. In addition, when the vibration generating device 2 can adjust the amplitude of vibration, the vibration determining unit 13 may further determine an amplitude of vibration generated by the vibration generating device 2, on the basis of the floating matter information. In addition, the vibration determining unit 13 may further determine an amplitude of vibration generated by the vibration generating device 2, on the basis of the installation location of the vibration generating device 2 determined by the installation location determining unit 12 or the installation location at which the vibration generating device 2 is installed in advance.

The vibration generating device control unit 14 controls the vibration generating device 2 so that the vibration generating device 2 vibrates at the frequency determined by the vibration determining unit 13. When the vibration determining unit 13 further determines an amplitude of vibration generated by the vibration generating device 2, the vibration generating device control unit 14 may control the vibration generating device 2 so that the vibration generating device 2 vibrates at the frequency and amplitude determined by the vibration determining unit 13. The vibration generating device control unit 14 may control the vibration generating device 2 so that the frequency or amplitude of vibration generated by the vibration generating device 2 changes temporally. In that case, for example, the vibration generating device control unit 14 may control the vibration generating device 2 so that the frequency or amplitude of vibration generated by the vibration generating device 2 changes temporally depending on the location of floating matter indicated by the floating matter information. Therefore, the vibration generating device 2 can generate a more appropriate water surface wave, depending on the location of floating matter.

The vibration generating device 2 vibrates a water surface, thereby generating a water surface wave. In the floating matter guidance system 100 including the floating matter guidance control device 1 according to the first embodiment, the vibration generating device 2 vibrates at the frequency determined by the vibration determining unit 13, on the basis of an instruction from the vibration generating device control unit 14, thereby generating a water surface wave. When the vibration determining unit 13 further determines an amplitude of vibration generated by the vibration generating device 2, the vibration generating device 2 may vibrate at the frequency and amplitude determined by the vibration determining unit 13, on the basis of an instruction from the vibration generating device control unit 14, thereby generating a water surface wave. Although the present embodiment describes a configuration in which the floating matter guidance system 100 includes one vibration generating device 2, the floating matter guidance system 100 can include a plurality of vibration generating devices 2. In that case, the plurality of vibration generating devices 2 are installed at respective different installation locations, and can generate waves of the same frequency or different frequencies. In addition, the plurality of vibration generating devices 2 may generate waves of the same frequency or different frequencies, thereby generating a combined wave in which the waves are superimposed on each other.

For example, when the floating matter guidance system 100 includes a plurality of vibration generating devices 2, the vibration generating device control unit 14 controls the plurality of vibration generating devices 2 so that the plurality of vibration generating devices 2 generate respective water surface waves with temporally-changed frequencies, thereby generating a combined wave in which two or more water surface waves are superimposed on each other.

A water surface wave generated by the vibration generating device 2 reaches floating matter on a water surface and guides the floating matter to a collection location. A direction in which the water surface wave generated by the vibration generating device 2 guides the floating matter can be a direction moving away from the installation location of the vibration generating device 2 or a direction approaching the installation location of the vibration generating device 2. The floating matter having reached the collection location may be collected by the user or may be collected by a collection device that performs collection using, for example, a method in which the floating mater is sucked up.

The output device 3 outputs the installation location of the vibration generating device 2 determined by the installation location determining unit 12. Examples of the output device 3 include a display, etc. For example, by referring to the installation location of the vibration generating device 2 outputted from the output device 3, the user installs the vibration generating device 2 at the installation location.

Next, a more detailed configuration of the vibration generating device 2 will be described with reference to a drawing. FIG. 2 is a schematic diagram showing a configuration of the vibration generating device 2 included in the floating matter guidance system 100 according to the first embodiment. As shown in FIG. 2, the vibration generating device 2 includes a vibration transfer plate 21 and a speaker 22, as devices that generate a water surface wave. In addition, the vibration generating device 2 includes a vibration generating unit 20 and a float 23.

The vibration generating unit 20 vibrates the vibration transfer plate 21 at a frequency determined by the vibration determining unit 13, on the basis of an instruction from the vibration generating device control unit 14. When the vibration determining unit 13 further determines an amplitude of vibration generated by the vibration generating device 2, the vibration generating unit 20 may vibrate the vibration transfer plate 21 at the amplitude determined by the vibration determining unit 13, on the basis of an instruction from the vibration generating device control unit 14.

The vibration transfer plate 21 transfers the vibration generated by the vibration generating unit 20 to a water surface, thereby generating a water surface wave. The speaker 22 vibrates a vibration plate at the frequency determined by the vibration determining unit 13, on the basis of an instruction from the vibration generating device control unit 14, thereby generating a water surface wave which is a sound wave. The speaker 22 can generate a water surface wave with a high frequency that cannot be generated by the vibration transfer plate 21. When the vibration determining unit 13 further determines an amplitude of vibration generated by the vibration generating device 2, the speaker 22 may vibrate the vibration plate at the amplitude determined by the vibration determining unit 13, on the basis of an instruction from the vibration generating device control unit 14, thereby generating a water surface wave which is a sound wave.

The float 23 generates buoyancy for maintaining the vibration transfer plate 21 and the speaker 22 at a location with a predetermined height relative to a water surface.

Note that the configuration of the vibration generating device 2 is not limited to that described above, and for example, the vibration generating device 2 may include one of the vibration transfer plate 21 and the speaker 22, or may not include the float 23. When the vibration generating device 2 does not include the vibration transfer plate 21, the vibration generating unit 20 is not necessary, either.

The vibration generating device control unit 14 switches a device that generates a water surface wave to one of the vibration transfer plate 21 and the speaker 22. For example, when vibration determined by the vibration determining unit 13 is high-frequency vibration that cannot be generated by the vibration transfer plate 21, the vibration generating device control unit 14 switches a device that generates a water surface wave to the speaker 22. Note that unlike this configuration, the vibration generating device control unit 14 may control both of the vibration transfer plate 21 and the speaker 22, as devices that each generate a water surface wave.

Functions of the water surface region identifying unit 10, the floating matter information obtaining unit 11, the vibration determining unit 13, the installation location determining unit 12, and the vibration generating device control unit 14 in the floating matter guidance control device 1 are implemented by a processing circuit. The processing circuit may be dedicated hardware or may be a central processing unit (CPU) that executes a program stored in a memory.

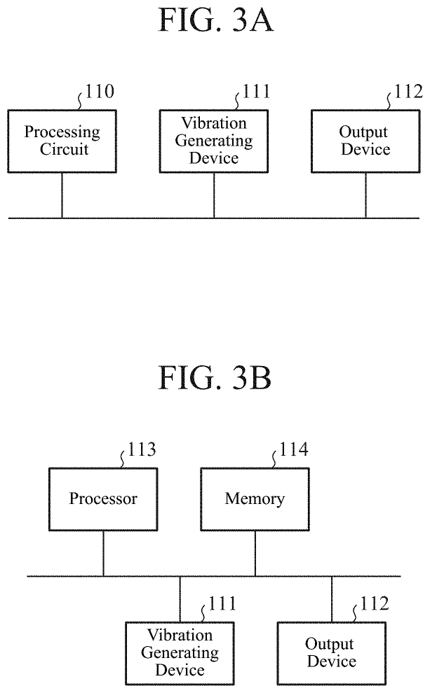

FIG. 3A is a block diagram showing a hardware configuration that implements the functions of the floating matter guidance control device 1. FIG. 3B is a block diagram showing a hardware configuration that executes software that implements the functions of the floating matter guidance control device 1. A vibration generating device 111 functions as the vibration generating device 2. An output device 112 functions as the output device 3.

When the above-described processing circuit is a processing circuit 110 which is dedicated hardware shown in FIG. 3A, the processing circuit 110 corresponds, for example, to a single circuit, a combined circuit, a programmed processor, a parallel programmed processor, an application specific integrated circuit (ASIC), a field-programmable gate array (FPGA), or a combination thereof.

Functions of the water surface region identifying unit 10, the floating matter information obtaining unit 11, the installation location determining unit 12, the vibration determining unit 13, and the vibration generating device control unit 14 in the floating matter guidance control device 1 may be implemented by different processing circuits, or the functions may be collectively implemented by a single processing circuit.

When the above-described processing circuit is a processor 113 shown in FIG. 3B, functions of the water surface region identifying unit 10, the floating matter information obtaining unit 11, the installation location determining unit 12, the vibration determining unit 13, and the vibration generating device control unit 14 in the floating matter guidance control device 1 are implemented by software, firmware, or a combination of software and firmware.

Note that the software or firmware is described as a program and stored in a memory 114.

The processor 113 implements functions of the water surface region identifying unit 10, the floating matter information obtaining unit 11, the installation location determining unit 12, the vibration determining unit 13, and the vibration generating device control unit 14 in the floating matter guidance control device 1 by reading and executing the program stored in the memory 114.

The program causes a computer to perform procedures or methods performed in the water surface region identifying unit 10, the floating matter information obtaining unit 11, the installation location determining unit 12, the vibration determining unit 13, and the vibration generating device control unit 14 in the floating matter guidance control device 1. The memory 114 may be a computer-readable storage medium having stored therein a program for causing a computer to function as the water surface region identifying unit 10, the floating matter information obtaining unit 11, the installation location determining unit 12, the vibration determining unit 13, and the vibration generating device control unit 14.

The memory 114 corresponds, for example, to a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disc, a compact disc, a MiniDisc, or a DVD.

Some of the functions of the water surface region identifying unit 10, the floating matter information obtaining unit 11, the installation location determining unit 12, the vibration determining unit 13, and the vibration generating device control unit 14 may be implemented by dedicated hardware, and some of the functions may be implemented by software or firmware.

For example, the functions of the water surface region identifying unit 10, the floating matter information obtaining unit 11, and the installation location determining unit 12 are implemented by a processing circuit which is dedicated hardware. The functions of the vibration determining unit 13 and the vibration generating device control unit 14 may be implemented by the processor 113 reading and executing a program stored in the memory 114.

As such, a processing circuit can implement each of the above-described functions by hardware, software, firmware, or a combination thereof.

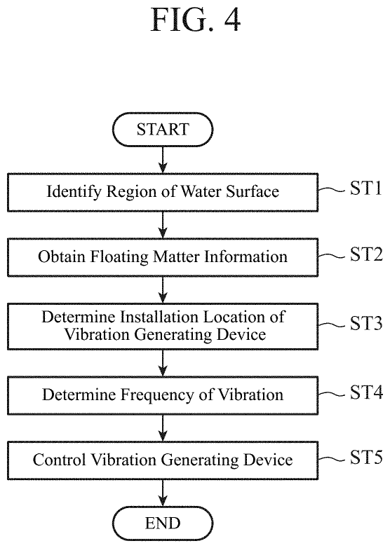

Next, operations of the floating matter guidance control device 1 according to the first embodiment will be described with reference to a drawing. FIG. 4 is a flowchart showing a floating matter guidance control method performed by the floating matter guidance control device 1 according to the first embodiment. The floating matter guidance control method shown in FIG. 4 is performed by the floating matter guidance control device 1 in a situation in which target floating matter floats on a water surface and the vibration generating device 2 for guiding the target floating matter is not yet installed at an installation location.

As shown in FIG. 4, the water surface region identifying unit 10 obtains data representing a region of a water surface, and identifies the region of a water surface on the basis of the data (step ST1).

Then, the floating matter information obtaining unit 11 obtains floating matter information about floating matter (step ST2).

Then, the installation location determining unit 12 determines an installation location of the vibration generating device 2, on the basis of the region of a water surface identified by the water surface region identifying unit 10 (step ST3). The output device 3 outputs the installation location of the vibration generating device 2 determined by the installation location determining unit 12, in the form of an image, etc. The user installs the vibration generating device 2 at the installation location.

Then, the vibration determining unit 13 determines a frequency of vibration generated by the vibration generating device 2 that generates a water surface wave by vibrating a water surface, on the basis of the floating matter information obtained by the floating matter information obtaining unit 11 (step ST4).

Then, the vibration generating device control unit 14 controls the vibration generating device 2 so that the vibration generating device 2 vibrates at the frequency determined by the vibration determining unit 13 (step ST5). The vibration generating device 2 vibrates at the frequency determined by the vibration determining unit 13, on the basis of an instruction from the vibration generating device control unit 14, thereby generating a water surface wave. The water surface wave generated by the vibration generating device 2 reaches the location of the floating matter on the water surface and guides the floating matter to a collection location.

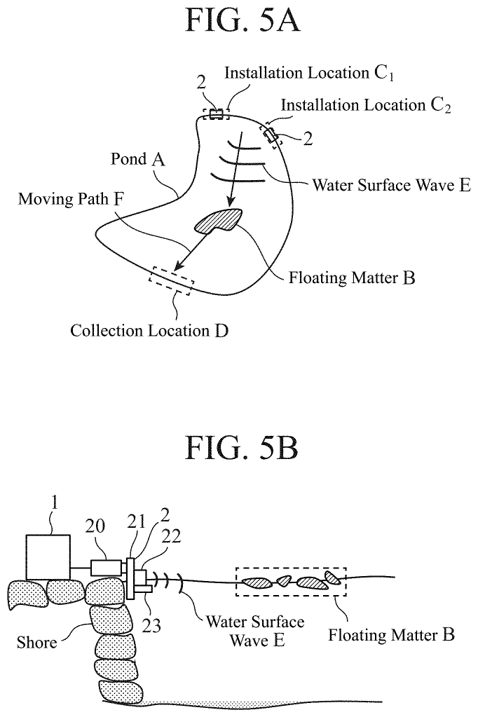

Next, a specific example of a floating matter guidance control method performed by the floating matter guidance control device 1 according to the first embodiment will be described with reference to drawings. FIGS. 5A and 5B each are a schematic diagram for describing a first specific example of a floating matter guidance control method performed by the floating matter guidance control device 1 according to the first embodiment. FIG. 5A shows a diagram of the entire region of a water surface of a pond A, and FIG. 5B is a diagram showing an area around an installation location Ci or an installation location C2 at which the floating matter guidance control device 1 and the vibration generating device 2 are installed.

At the above-described step ST1, the water surface region identifying unit 10 obtains data representing the region of a water surface of a pond A, and identifies the region of the water surface of the pond A on the basis of the data. Then, at the above-described step ST2, the floating matter information obtaining unit 11 obtains floating matter information about floating matter B.

Then, at the above-described step ST3, the installation location determining unit 12 determines the installation location C₁ and the installation location C₂ of the vibration generating devices 2 on the basis of the region of the water surface of the pond A identified by the water surface region identifying unit 10. The output device 3 outputs the installation location C₁ and the installation location C₂ of the vibration generating devices 2 determined by the installation location determining unit 12, in the form of an image, etc. The user installs the vibration generating devices 2 at the installation location C₁ and at the installation location C₂ on a shore.

Then, at the above-described step ST4, the vibration determining unit 13 determines a frequency of vibration generated by the vibration generating device 2 installed at the installation location C₁ and a frequency of vibration generated by the vibration generating device 2 installed at the installation location C₂, on the basis of the floating matter information about the floating matter B which is obtained by the floating matter information obtaining unit 11.

Then, at the above-described step ST5, the vibration generating device control unit 14 controls the two vibration generating devices 2 so that the two vibration generating devices 2 vibrate at the respective frequencies of vibration determined by the vibration determining unit 13. The two vibration generating devices 2 vibrate at the respective frequencies of vibration determined by the vibration determining unit 13, on the basis of an instruction from the vibration generating device control unit 14, thereby generating respective water surface waves. The two water surface waves generated in this way are superimposed on each other, thereby generating a water surface wave E which is a combined wave, and guiding the floating matter B to a collection location D along a moving path F.

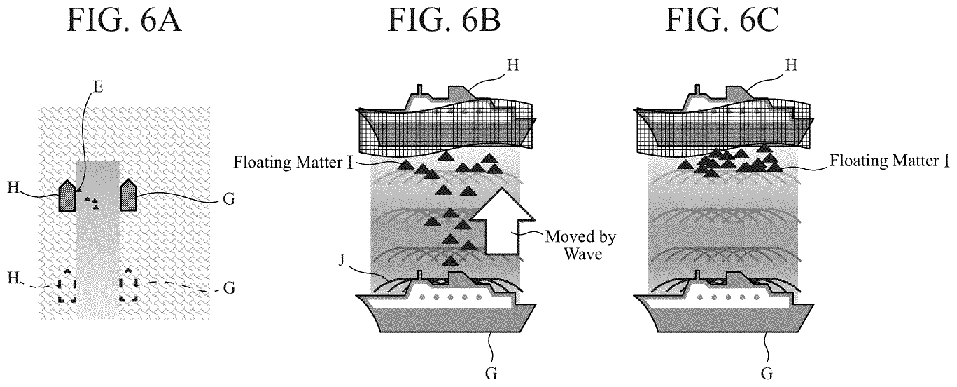

Next, a second specific example of a floating matter guidance control method performed by the floating matter guidance control device 1 according to the first embodiment will be described with reference to drawings. FIGS. 6A, 6B, and 6C each are a schematic diagram for describing the second specific example of a floating matter guidance control method performed by the floating matter guidance control device 1 according to the first embodiment. A boat G in FIGS. 6A, 6B, and 6C is a boat having installed thereon the vibration generating device 2 which is not shown. In addition, a boat H in FIGS. 6A, 6B, and 6C is a boat that collects floating matter. As shown in FIG. 6A, the boat G represented by a dotted line and the boat H represented by a dotted line move to respective locations of the boat G and the boat H which are represented by shading. During the movement of the boat G and the boat H shown in FIG. 6A, as shown in FIG. 6B, a water surface wave J generated by the vibration generating device 2 installed on the boat G guides floating matter I, and as shown in FIG. 6C, the boat H collects the floating matter I. Note that in the second specific example, the floating matter guidance control device 1 performs neither of the above-described steps ST1 and ST3. Namely, the floating matter guidance control device 1 in the second specific example does not need to include one or both of the water surface region identifying unit 10 and the installation location determining unit 12.

More specifically, in the second specific example, at the above-described step ST2, the floating matter information obtaining unit 11 obtains floating matter information about the floating matter I. Examples of the floating matter I include oil floating in the sea, etc.

Then, at the above-described step ST4, the vibration determining unit 13 determines a frequency of vibration generated by the vibration generating device 2 installed on the boat G, on the basis of the floating matter information about the floating matter I which is obtained by the floating matter information obtaining unit 11.

Then, at the above-described step ST5, the vibration generating device control unit 14 controls the vibration generating device 2 installed on the boat G so that the vibration generating device 2 vibrates at the frequency of vibration determined by the vibration determining unit 13. The vibration generating device 2 vibrates at the frequency of vibration determined by the vibration determining unit 13, on the basis of an instruction from the vibration generating device control unit 14, thereby generating the water surface wave J and guiding the floating matter I to the boat H.

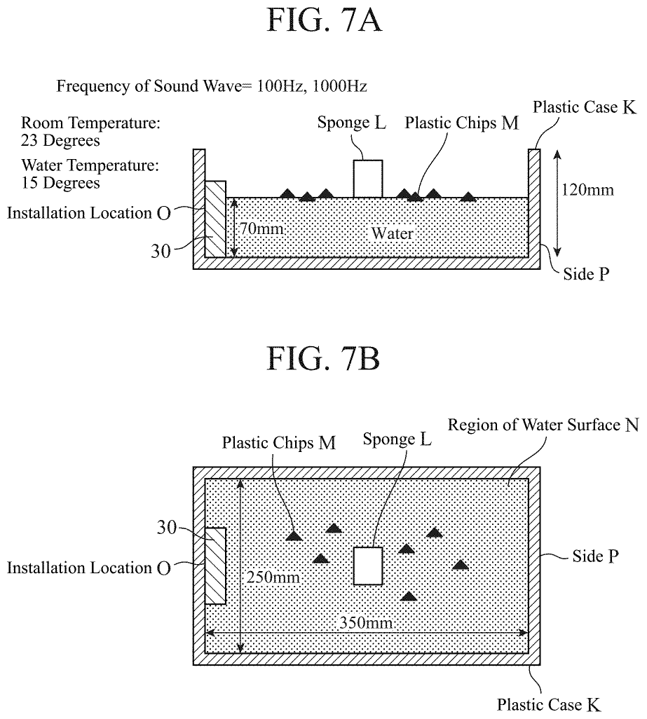

Next, a third specific example of a floating matter guidance control method performed by the floating matter guidance control device 1 according to the first embodiment will be described with reference to drawings. FIGS. 7A and 7B each are a schematic diagram for describing the third specific example of a floating matter guidance control method performed by the floating matter guidance control device 1 according to the first embodiment. FIG. 7A is a side view of a plastic case K having water therein, as viewed from the side. FIG. 7B is a top view of the plastic case K having water therein, as viewed from the top. As shown in FIGS. 7A and 7B, a sponge L which is floating matter and plastic chips M which are floating matter float on a water surface in the plastic case K. Compared with the above-described vibration generating device 2, a vibration generating device 30 does not include the vibration transfer plate 21 and the float 23 and includes only the speaker 22 of the vibration generating device 2. In addition, the vibration generating device 30 is connected to the floating matter guidance control device 1 which is not shown.

First, at the above-described step ST1, the water surface region identifying unit 10 obtains data representing a region N of a water surface in the plastic case K, and identifies the region N of a water surface in the plastic case K on the basis of the data. Then, at the above-described step ST2, the floating matter information obtaining unit 11 obtains floating matter information about the sponge L.

Then, at the above-described step ST3, the installation location determining unit 12 determines an installation location O of the vibration generating device 30, on the basis of the region N of a water surface in the plastic case K which is identified by the water surface region identifying unit 10. The output device 3 outputs the installation location O of the vibration generating device 30 determined by the installation location determining unit 12, in the form of an image, etc. The user installs the vibration generating device 30 at the installation location O.

Then, at the above-described step ST4, the vibration determining unit 13 determines a frequency of vibration generated by the vibration generating device 30, on the basis of the floating matter information about the sponge L which is obtained by the floating matter information obtaining unit 11, the region N identified by the water surface region identifying unit 10, and the installation location O determined by the installation location determining unit 12. More specifically, the vibration determining unit 13 predicts generation of a reflected wave on a side P of the plastic case K, on the basis of the region N identified by the water surface region identifying unit 10 and the installation location O determined by the installation location determining unit 12. Then, the vibration determining unit 13 predicts a combined wave in which a water surface wave generated by the vibration generating device 30 is superimposed on the reflected wave on the side P, and determines a frequency of vibration generated by the vibration generating device 30 so that the combined wave is a wave suited to guiding the sponge L indicated by the floating matter information.

Then, at the above-described step ST5, the vibration generating device control unit 14 controls the vibration generating device 30 so that the vibration generating device 30 vibrates at the frequency of vibration determined by the vibration determining unit 13. The vibration generating device 30 vibrates at the frequency of vibration determined by the vibration determining unit 13, on the basis of an instruction from the vibration generating device control unit 14, thereby generating a water surface wave and guiding the sponge L to a location near the side P which is a collection location. Note that at this time, the plastic chips M are not moved by the water surface wave generated by the vibration generating device 30.

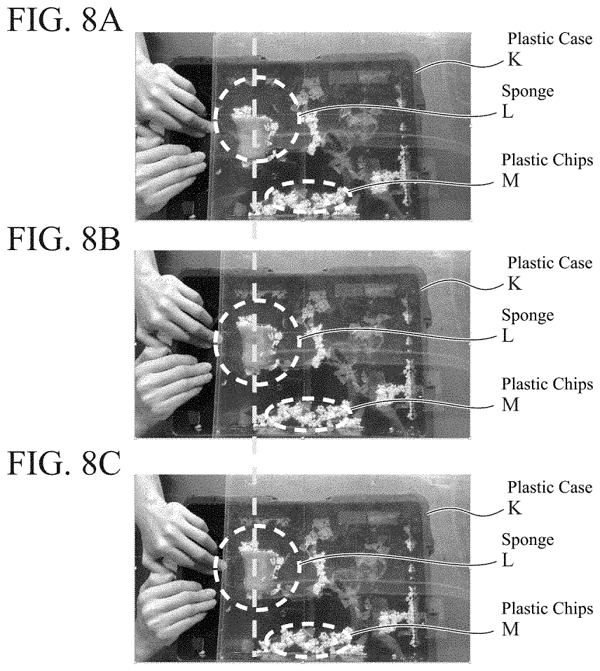

Next, an implementation example of the third specific example of a floating matter guidance control method performed by the floating matter guidance control device 1 according to the first embodiment will be described with reference to drawings. First, FIGS. 8A, 8B, and 8C each are a diagram for describing a comparative example of a case in which the floating matter guidance control device 1 in the third specific example has not performed the above-described floating matter guidance control method. In the comparative example, none of a process of identifying a region of a water surface, a process of obtaining floating matter information, a process of determining an installation location of the vibration generating device, and a process of determining a frequency of vibration are performed, and the vibration generating device 30 installed at the installation location O is simply controlled so that the vibration generating device 30 vibrates at a frequency of 1000 Hz. FIG. 8A is a diagram showing the states of the sponge L and the plastic chips M a 0 seconds after the vibration generating device 30 starts vibration. FIG. 8B is a diagram showing the states of the sponge L and the plastic chips M at 5 seconds after the vibration generating device 30 starts vibration. FIG. 8C is a diagram showing the states of the sponge L and the plastic chips M at 10 seconds after the vibration generating device 30 starts vibration. As shown in FIGS. 8A, 8B, and 8C, none of the sponge L and the plastic chips M have been moved by a water surface wave generated by the vibration with a frequency of 1000 Hz of the vibration generating device 30.

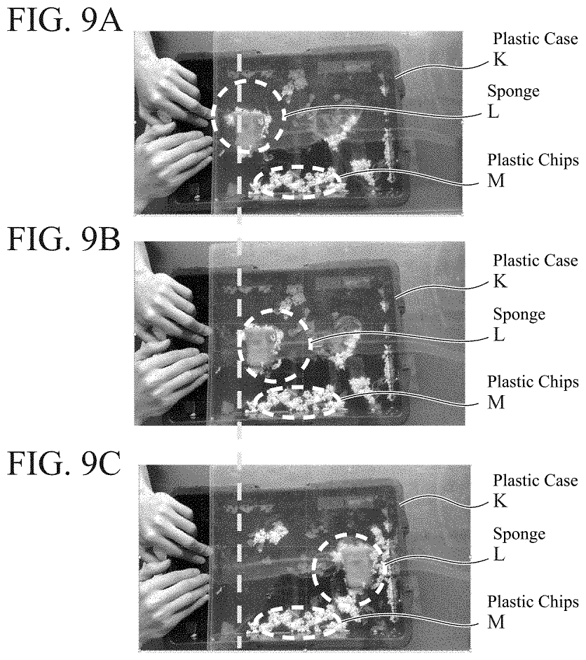

FIGS. 9A, 9B, and 9C each are a diagram for describing an implementation example of a case in which the vibration determining unit 13 in the above-described third specific example determines a frequency of vibration generated by the vibration generating device 30 to be 100 Hz, and the vibration generating device 30 is controlled so that the vibration generating device 30 vibrates at a frequency of 100 Hz. FIG. 9A is a diagram showing the states of the sponge L and the plastic chips M at 0 seconds after the vibration generating device 30 starts vibration. FIG. 9B is a diagram showing the states of the sponge L and the plastic chips M at 5 seconds after the vibration generating device 30 starts vibration. FIG. 9C is a diagram showing the states of the sponge L and the plastic chips M 10 at seconds after the vibration generating device 30 starts vibration. As shown in FIGS. 9A, 9B, and 9C, the sponge L has been moved by a water surface wave generated by the vibration with a frequency of 100 Hz in the vibration generating device 30. Note that at this time, the plastic chips M have not been moved by the water surface wave generated by the vibration with a frequency of 100 Hz in the vibration generating device 30.

As described above, the floating matter guidance control device 1 according to the first embodiment includes the floating matter information obtaining unit 11 that obtains floating matter information about floating matter on a water surface; the vibration determining unit 13 that determines a frequency of vibration generated by the vibration generating device 2 that generates a water surface wave by vibrating a water surface, on the basis of the floating matter information obtained by the floating matter information obtaining unit 11; and the vibration generating device control unit 14 that controls the vibration generating device 2 so that the vibration generating device 2 vibrates at the frequency determined by the vibration determining unit 13.

According to the above-described configuration, it is possible to cause the vibration generating device 2 to vibrate at a frequency suited to guiding floating matter, on the basis of floating matter information. By a water surface wave generated in this way, the floating matter can be guided to a collection location. Thus, floating matter on a water surface can be collected without moving a person or a device to a location near the floating matter on the water surface.

In addition, the floating matter guidance control device 1 according to the first embodiment further includes the water surface region identifying unit 10 that identifies a region of a water surface.

According to the above-described configuration, when an installation location of the vibration generating device 2 is determined on the basis of an identified region of a water surface, the installation location of the vibration generating device 2 can be appropriately determined. In addition, when the vibration determining unit 13 determines a frequency of vibration, a reflected wave can be predicted as necessary by referring to the region of a water surface, and thus, the frequency of vibration can be appropriately determined taking into account generation of the reflected wave.

In addition, the floating matter guidance control device 1 according to the first embodiment further includes the installation location determining unit 12 that determines an installation location of the vibration generating device 2 on the basis of the region of a water surface identified by the water surface region identifying unit 10.

According to the above-described configuration, an installation location of the vibration generating device 2 can be appropriately determined on the basis of an identified region of a water surface. In addition, when the vibration determining unit 13 determines a frequency of vibration, a water surface wave or a reflected wave to be generated on the basis of the installation location can be predicted as necessary. Thus, the frequency of vibration can be appropriately determined.

In addition, in the floating matter guidance control device 1 according to the first embodiment, the vibration generating device 2 includes the vibration transfer plate 21 and the speaker 22 as devices that generate a water surface wave, and the vibration generating device control unit 14 switches a device that generates a water surface wave to one of the vibration transfer plate 21 and the speaker 22.

According to the above-described configuration, when there is a need to generate vibration with a frequency that cannot be generated by one of the vibration transfer plate 21 and the speaker 22, a device that generates a water surface wave can be switched to the other one of the vibration transfer plate 21 and the speaker 22. Thus, water surface waves that handle various types of floating matter can be generated over a case in which the vibration generating device 2 includes only one of the vibration transfer plate 21 and the speaker 22.

In addition, in the floating matter guidance control device 1 according to the first embodiment, the vibration generating device control unit 14 controls the vibration generating device 2 so that the frequency of vibration generated by the vibration generating device 2 changes temporally.

According to the above-described configuration, a water surface wave whose frequency changes temporally can be generated. Thus, water surface waves that handle various types of floating matter or a water surface wave based on the location of floating matter can be generated over a case in which the frequency of vibration is not changed temporally.

### Second Embodiment

The first embodiment describes a configuration in which the vibration determining unit 13 in the floating matter guidance control device 1 determines a frequency of vibration generated by the vibration generating device 2, on the basis of floating matter information. However, a water surface wave generated by the vibration can change depending on the environment of a water surface such as water depth, water temperature, and atmospheric pressure. Hence, in the second embodiment, a measuring device 5 floating on a water surface obtains environmental information about an environment of the water surface. In a floating matter guidance control device 40, the vibration determining unit 13 determines a frequency of vibration generated by the vibration generating device 2, by performing a simulation of a water surface wave generated on a water surface, further on the basis of the environmental information.

The second embodiment will be described below with reference to a drawing. Note that components having the same functions as those described in the first embodiment are given the same reference signs and description thereof is omitted.

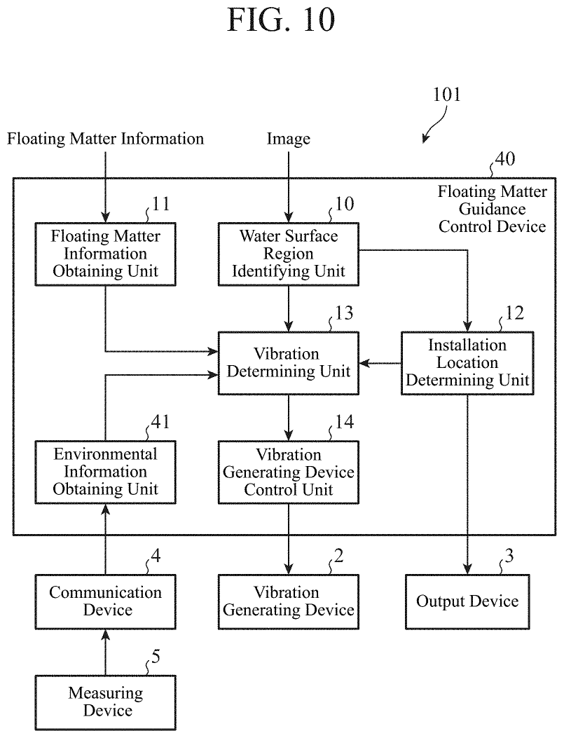

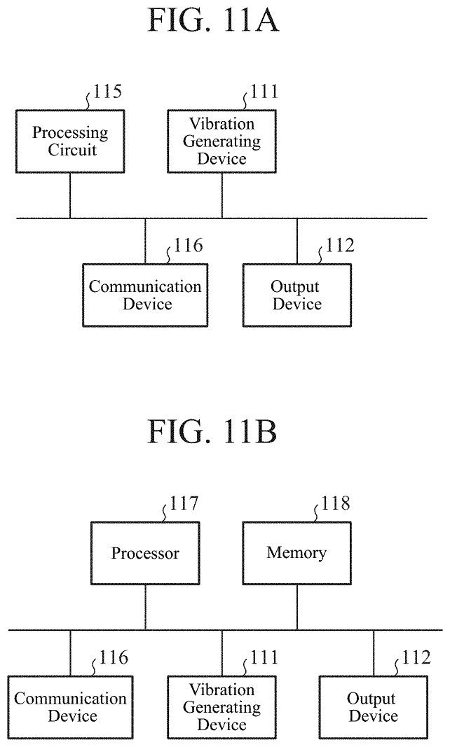

FIG. 10 is a block diagram showing a configuration of a floating matter guidance system 101 including the floating matter guidance control device 40 according to the second embodiment. As shown in FIG. 10, the floating matter guidance system 101 includes a communication device 4 and the measuring device 5 in addition to the components of the floating matter guidance system 100 according to the first embodiment. In addition, as shown in FIG. 10, the floating matter guidance control device 40 further includes an environmental information obtaining unit 41 in addition to the components of the floating matter guidance control device 1 according to the first embodiment.

The measuring device 5 has a function of measuring an environment of a water surface, in a state in which the measuring device 5 floats on the water surface by a buoy, etc. The measuring device 5 measures an environment of a water surface, thereby obtaining environmental information about the environment of the water surface. Examples of the measuring device 5 include an ultrasonic sensor that measures water depth, a temperature sensor that measures water temperature, an atmospheric pressure sensor that measures atmospheric pressure, etc. Examples of the environmental information include water depth, water temperature, and atmospheric pressure. In addition, the measuring device 5 measures a location on a water surface of the measuring device 5, thereby obtaining location information about the location on the water surface of the measuring device 5. The measuring device 5 transmits the obtained environmental information and location information to the communication device 4. Note that in the present embodiment it is assumed that the measuring device 5 is not located near floating matter, before the floating matter guidance control device 40 performs a measuring device guidance control method which will be described later.

The communication device 4 receives the environmental information and the location information from the measuring device 5, and outputs the environmental information and the location information to the environmental information obtaining unit 41.

The environmental information obtaining unit 41 obtains the environmental information and the location information from the communication device 4, and outputs the environmental information and the location information to the vibration determining unit 13.

The vibration determining unit 13 according to the second embodiment calculates a direction of movement on the water surface of the measuring device 5 on the basis of the location information obtained by the environmental information obtaining unit 41, and determines whether or not the measuring device 5 moves toward a specific location, on the basis of the direction of movement. The specific location can be a location on the water surface of floating matter indicated by floating matter information obtained by the floating matter information obtaining unit 11. When the vibration determining unit 13 determines that the measuring device 5 does not move toward the specific location, the vibration determining unit 13 changes the frequency of vibration generated by the vibration generating device 2. When the vibration determining unit 13 determines that the measuring device 5 does not move toward the specific location, the vibration determining unit 13 may change the frequency of vibration generated by the vibration generating device 2, on the basis of the environmental information obtained by the environmental information obtaining unit 41.

In addition, the vibration determining unit 13 determines a frequency of vibration generated by the vibration generating device 2, by performing a simulation of a water surface wave generated on the water surface, on the basis of the floating matter information obtained by the floating matter information obtaining unit 11 and the environmental information obtained by the environmental information obtaining unit 41. The vibration determining unit 13 may further determine an amplitude of vibration generated by the vibration generating device 2, by performing a simulation of a water surface wave generated on the water surface, on the basis of the floating matter information obtained by the floating matter information obtaining unit 11 and the environmental information obtained by the environmental information obtaining unit 41. The vibration determining unit 13 may determine a frequency of vibration generated by the vibration generating device 2, by performing a simulation of a water surface wave generated on the water surface, further on the basis of a region of the water surface identified by the water surface region identifying unit 10. More specifically, for example, the vibration determining unit 13 determines the frequency and amplitude of a water surface wave that guides floating matter at a location on the water surface at which the floating matter is present, on the basis of the floating matter information obtained by the floating matter information obtaining unit 11. Then, in order that a water surface wave with the frequency and the amplitude is generated at the location on the water surface in a simulation, the vibration determining unit 13 sets the frequency and amplitude of vibration and a location at which the vibration is generated in a simulation, on the basis of the region of the water surface identified by the water surface region identifying unit 10 and the environmental information obtained by the environmental information obtaining unit 41. Then, the vibration determining unit 13 determines the frequency and amplitude of vibration set in the simulation, as the frequency and amplitude of vibration generated by the vibration generating device 2. The installation location determining unit 12 determines the location at which the vibration is generated which is set in the simulation by the vibration determining unit 13, as an installation location of the vibration generating device 2.

Functions of the water surface region identifying unit 10, the floating matter information obtaining unit 11, the vibration determining unit 13, the installation location determining unit 12, the vibration generating device control unit 14, and the environmental information obtaining unit 41 in the floating matter guidance control device 40 is implemented by a processing circuit. The processing circuit may be dedicated hardware or may be a central processing unit (CPU) that executes a program stored in a memory.

FIG. 11A is a block diagram showing a hardware configuration that implements the functions of the floating matter guidance control device 40. FIG. 11B is a block diagram showing a hardware configuration that executes software that implements the functions of the floating matter guidance control device 40. The vibration generating device 111 functions as the vibration generating device 2. The output device 112 functions as the output device 3. A communication device 116 functions as the communication device 4.

When the above-described processing circuit is a processing circuit 115 which is dedicated hardware shown in FIG. 11A, the processing circuit 115 corresponds, for example, to a single circuit, a combined circuit, a programmed processor, a parallel programmed processor, an application specific integrated circuit (ASIC), a field-programmable gate array (FPGA), or a combination thereof.

Functions of the water surface region identifying unit 10, the floating matter information obtaining unit 11, the installation location determining unit 12, the vibration determining unit 13, the vibration generating device control unit 14, and the environmental information obtaining unit 41 in the floating matter guidance control device 40 may be implemented by different processing circuits, or the functions may be collectively implemented by a single processing circuit.

When the above-described processing circuit is a processor 117 shown in FIG. 11B, functions of the water surface region identifying unit 10, the floating matter information obtaining unit 11, the installation location determining unit 12, the vibration determining unit 13, the vibration generating device control unit 14, and the environmental information obtaining unit 41 in the floating matter guidance control device 40 is implemented by software, firmware, or a combination of software and firmware.

Note that the software or firmware is described as a program and stored in a memory 118.

The processor 117 implements functions of the water surface region identifying unit 10, the floating matter information obtaining unit 11, the installation location determining unit 12, the vibration determining unit 13, the vibration generating device control unit 14, and the environmental information obtaining unit 41 in the floating matter guidance control device 40 by reading and executing the program stored in the memory 118.

The program causes a computer to perform procedures or methods performed in the water surface region identifying unit 10, the floating matter information obtaining unit 11, the installation location determining unit 12, the vibration determining unit 13, the vibration generating device control unit 14, and the environmental information obtaining unit 41 in the floating matter guidance control device 40. The memory 118 may be a computer-readable storage medium having stored therein a program for causing a computer to function as the water surface region identifying unit 10, the floating matter information obtaining unit 11, the installation location determining unit 12, the vibration determining unit 13, the vibration generating device control unit 14, and the environmental information obtaining unit 41.

The memory 118 corresponds, for example, to a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disc, a compact disc, a MiniDisc, or a DVD.

Some of the functions of the water surface region identifying unit 10, the floating matter information obtaining unit 11, the installation location determining unit 12, the vibration determining unit 13, the vibration generating device control unit 14, and the environmental information obtaining unit 41 may be implemented by dedicated hardware, and some of the functions may be implemented by software or firmware.

For example, the functions of the water surface region identifying unit 10, the floating matter information obtaining unit 11, and the installation location determining unit 12 are implemented by a processing circuit which is dedicated hardware. The functions of the vibration determining unit 13, the vibration generating device control unit 14, and the environmental information obtaining unit 41 may be implemented by the processor 117 reading and executing a program stored in the memory 118.

As such, a processing circuit can implement each of the above-described functions by hardware, software, firmware, or a combination thereof.

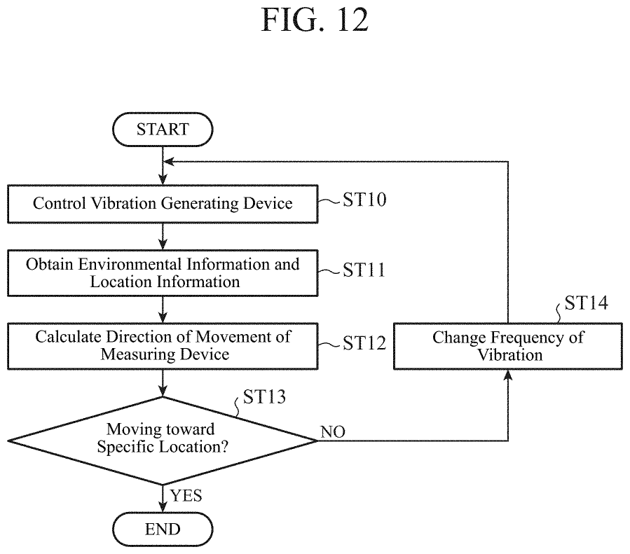

Next, operations of the floating matter guidance control device 40 according to the second embodiment will be described with reference to drawings. First, a measuring device guidance control method performed by the floating matter guidance control device 40 will be described. FIG. 12 is a flowchart showing a measuring device guidance control method performed by the floating matter guidance control device 40 according to the second embodiment. Note that it is assumed that before the floating matter guidance control device 40 performs the measuring device guidance control method, the user has thrown the measuring device 5 in a water surface. Note also that it is assumed that the vibration generating device 2 is installed at any location on an outer edge such as a shore that surrounds a region of the water surface.

As shown in FIG. 12, first, the vibration generating device control unit 14 controls the vibration generating device 2 so that the vibration generating device 2 vibrates at a frequency determined by the vibration determining unit 13 (step ST10). When step ST10 is performed for the first time after the floating matter guidance control device 40 starts a measuring device guidance control method, the frequency determined by the vibration determining unit 13 at step ST10 is any frequency. The vibration generating device 2 vibrates on the basis of an instruction from the vibration generating device control unit 14, thereby generating a water surface wave. The water surface wave reaches the measuring device 5 on a water surface. The measuring device 5 measures an environment of the water surface on the water surface, thereby obtaining environmental information. The measuring device 5 measures a location on the water surface of the measuring device 5 on the water surface, thereby further obtaining location information. The measuring device 5 transmits the obtained environmental information and location information to the communication device 4, and the communication device 4 outputs the received environmental information and location information to the environmental information obtaining unit 41.

Then, the environmental information obtaining unit 41 obtains the environmental information about the environment of the water surface and the location information about the location on the water surface of the measuring device 5, from the communication device 4 (step ST11). The environmental information obtaining unit 41 outputs the environmental information and the location information to the vibration determining unit 13.

Then, the vibration determining unit 13 calculates a direction of movement on the water surface of the measuring device 5 on the basis of the location information obtained by the environmental information obtaining unit 41 (step ST12).

Then, the vibration determining unit 13 determines, on the basis of the calculated direction of movement, whether or not the measuring device 5 moves toward a specific location (step ST13). If the vibration determining unit 13 determines that the measuring device 5 moves toward the specific location (YES at step ST13), then the processing ends.

If the vibration determining unit 13 determines, at step ST13, that the measuring device 5 does not move toward the specific location (NO at step ST13), then the vibration determining unit 13 changes the frequency of vibration generated by the vibration generating device 2 (step ST14). The floating matter guidance control device 40 returns the processing to the process at step ST10, and at step ST10, the vibration generating device control unit 14 controls the vibration generating device 2 so that the vibration generating device 2 vibrates at the frequency changed by the vibration determining unit 13.

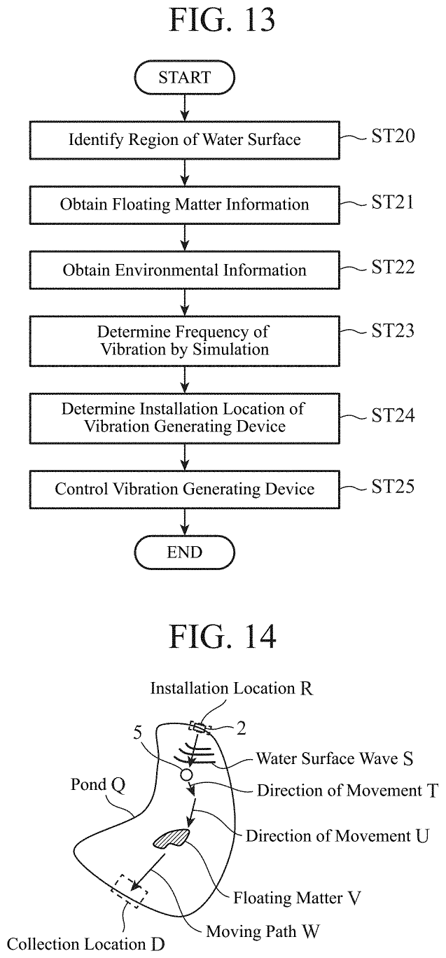

Next, a floating matter guidance control method performed by the floating matter guidance control device 40 according to the second embodiment will be described. FIG. 13 is a flowchart showing a floating matter guidance control method performed by the floating matter guidance control device 40 according to the second embodiment. Note that it is assumed that before the floating matter guidance control device 40 performs the floating matter guidance control method, the above-described measuring device guidance control method has performed and thus the measuring device 5 is located near floating matter. The measuring device 5 newly measures an environment of the water surface near the floating matter on the water surface, thereby newly obtaining environmental information. The measuring device 5 transmits the obtained environmental information to the communication device 4, and the communication device 4 outputs the received environmental information to the environmental information obtaining unit 41.

As shown in FIG. 13, first, the water surface region identifying unit 10 obtains data representing a region of a water surface, and identifies the region of a water surface on the basis of the data (step ST20).

Then, the floating matter information obtaining unit 11 obtains floating matter information about floating matter (step ST21).

Then, the environmental information obtaining unit 41 obtains environmental information from the communication device 4 (step ST22). The environmental information obtaining unit 41 outputs the obtained environmental information to the vibration determining unit 13.

Then, the vibration determining unit 13 determines a frequency of vibration generated by the vibration generating device 2, by performing a simulation of a water surface wave to be generated on the water surface, on the basis of the floating matter information obtained by the floating matter information obtaining unit 11 and the environmental information obtained by the environmental information obtaining unit 41 (step ST23).

Then, the installation location determining unit 12 determines a location at which the vibration is generated which is set in the simulation by the vibration determining unit 13, as an installation location of the vibration generating device 2 (step ST24). The output device 3 outputs the installation location of the vibration generating device 2 determined by the installation location determining unit 12, in the form of an image, etc. The user installs the vibration generating device 2 at the installation location.

Then, the vibration generating device control unit 14 controls the vibration generating device 2 so that the vibration generating device 2 vibrates at the frequency determined by the vibration determining unit 13 (step ST25). The vibration generating device 2 vibrates at the frequency determined by the vibration determining unit 13, on the basis of an instruction from the vibration generating device control unit 14, thereby generating a water surface wave. The water surface wave generated by the vibration generating device 2 reaches the location of the floating matter on the water surface, and guides the floating matter to a collection location.

Next, a specific example of a measuring device guidance control method and a floating matter guidance control method which are performed by the floating matter guidance control device 40 according to the second embodiment will be described with reference to a drawing. FIG. 14 is a schematic diagram for describing a specific example of a measuring device guidance control method and a floating matter guidance control method which are performed by the floating matter guidance control device 40 according to the second embodiment. Note that it is assumed that before the floating matter guidance control device 40 performs the measuring device guidance control method, the user has thrown the measuring device 5 in a water surface of a pond Q. Note also that it is assumed that the vibration generating device 2 is installed, in advance, at any location on an outer edge such as a shore that surrounds a region of the water surface. Hence, it is assumed that the floating matter guidance control device 40 does not perform determination of an installation location of the vibration generating device 2 at the above-described step ST24.

At the above-described step ST10, the vibration generating device control unit 14 controls the vibration generating device 2 installed at an installation location R so that the vibration generating device 2 vibrates at any frequency. The vibration generating device 2 installed at the installation location R vibrates on the basis of an instruction from the vibration generating device control unit 14, thereby generating a water surface wave S.

Then, at the above-described step ST11, the environmental information obtaining unit 41 obtains environmental information about an environment of the water surface and location information about the location on the water surface of the measuring device 5, from the measuring device 5 through the communication device 4. The environmental information obtaining unit 41 outputs the environmental information and the location information to the vibration determining unit 13.

Then, at the above-described step ST12, the vibration determining unit 13 calculates a direction of movement T on the water surface of the measuring device 5, on the basis of the location information obtained by the environmental information obtaining unit 41.

Then, at the above-described step ST13, the vibration determining unit 13 determines, on the basis of the calculated direction of movement T, that the measuring device 5 does not move toward a specific location, and at the above-described step ST14, the vibration determining unit 13 changes the frequency of vibration generated by the vibration generating device 2. The floating matter guidance control device 40 returns the processing to the process at step ST10, and at step ST10, the vibration generating device control unit 14 controls the vibration generating device 2 so that the vibration generating device 2 vibrates at the frequency changed by the vibration determining unit 13. The vibration generating device 2 vibrates on the basis of an instruction from the vibration generating device control unit 14, thereby generating a water surface wave different from the water surface wave S. The water surface wave guides the measuring device 5 to a location on the water surface of floating matter V along a direction of movement U.

The measuring device 5 newly measures an environment of the water surface near the floating matter V on the water surface, thereby newly obtaining environmental information. The measuring device 5 transmits the obtained environmental information to the communication device 4, and the communication device 4 outputs the received environmental information to the environmental information obtaining unit 41.

Then, at the above-described step ST11, the environmental information obtaining unit 41 newly obtains the environmental information about the environment of the water surface and location information about the location on the water surface of the measuring device 5, from the measuring device 5 through the communication device 4. Then, at the above-described step ST12, the vibration determining unit 13 calculates the direction of movement U on the water surface of the measuring device 5, on the basis of the location information obtained by the environmental information obtaining unit 41. Then, at the above-described step ST13, the vibration determining unit 13 determines, on the basis of the calculated direction of movement U, that the measuring device 5 moves toward the specific location, and the floating matter guidance control device 40 ends the processing for the measuring device guidance control method.

Then, at the above-described step ST20, the water surface region identifying unit 10 obtains data representing a region of a water surface, and identifies the region of the water surface of the pond Q on the basis of the data. Then, at the above-described step ST21, the floating matter information obtaining unit 11 obtains floating matter information about the floating matter V. Then, at the above-described step ST22, the environmental information obtaining unit 41 obtains environmental information, through the communication device 4, from the measuring device 5 floating on the water surface near the floating matter V. The environmental information obtaining unit 41 outputs the obtained environmental information to the vibration determining unit 13.

Then, at the above-described step ST23, the vibration determining unit 13 determines a frequency of vibration generated by the vibration generating device 2, by performing a simulation of a water surface wave generated on the water surface of the pond Q, on the basis of the floating matter information obtained by the floating matter information obtaining unit 11 and the environmental information obtained by the environmental information obtaining unit 41. Then, at step ST25, the vibration generating device control unit 14 controls the vibration generating device 2 so that the vibration generating device 2 vibrates at the frequency of vibration determined by the vibration determining unit 13. The vibration generating device 2 vibrates at the frequency of vibration determined by the vibration determining unit 13, on the basis of an instruction from the vibration generating device control unit 14, thereby generating a water surface wave. The water surface wave generated in this way guides the floating matter V to a collection location D along a moving path W.

As described above, in the floating matter guidance control device 40 according to the second embodiment, the vibration determining unit 13 determines a frequency of vibration generated by the vibration generating device 2, by performing a simulation of a water surface wave generated on a water surface, on the basis of floating matter information obtained by the floating matter information obtaining unit 11.

A water surface wave generated by vibration of the vibration generating device 2, for example, changes or attenuates by the influence of an environment, when the water surface wave has reached floating matter. However, according to the above-described configuration, since a water surface wave to reach floating matter can be predicted by simulation, a frequency of vibration generated by the vibration generating device 2 can be appropriately determined so that the water surface wave having reached the floating matter has a frequency, an amplitude, or the like, at which the water surface wave can guide the floating matter.

In addition, the floating matter guidance control device 40 according to the second embodiment further includes the environmental information obtaining unit 41 that obtains environmental information about an environment of a water surface, and the vibration determining unit 13 determines a frequency of vibration generated by the vibration generating device 2, by performing a simulation of a water surface wave generated on the water surface, further on the basis of the environmental information obtained by the environmental information obtaining unit 41.

A water surface wave generated by vibration of the vibration generating device 2 can change depending on the environment of a water surface such as water depth, water temperature, and atmospheric pressure. However, according to the above-described configuration, since a water surface wave to reach floating matter can be predicted by simulation on the basis of those pieces of environmental information about the environment of a water surface, a frequency of vibration generated by the vibration generating device 2 can be appropriately determined so that the water surface wave having reached the floating matter has a frequency, an amplitude, or the like, at which the water surface wave can guide the floating matter.

In addition, in the floating matter guidance control device 40 according to the second embodiment, the environmental information obtaining unit 41 further obtains location information about a location of the measuring device 5 at which environmental information is obtained by measuring an environment of a water surface, and when the vibration determining unit 13 determines, on the basis of the location information obtained by the environmental information obtaining unit 41, that the measuring device 5 does not move toward a specific location, the vibration determining unit 13 changes the frequency of vibration generated by the vibration generating device 2.

According to the above-described configuration, upon guiding the measuring device 5 to a specific location such as a location near floating matter, when the measuring device 5 does not move toward the specific location, the frequency of vibration generated by the vibration generating device 2 is changed, by which the measuring device 5 can be guided so as to move toward the specific location.

Note that in the invention of the present application, a free combination of the embodiments, modifications to any component of each of the embodiments, or omissions of any component in each of the embodiments are possible within the scope of the invention.

### INDUSTRIAL APPLICABILITY

A floating matter guidance control device according to the invention can collect floating matter on a water surface without moving a person or a device to a location near the floating matter on the water surface, and thus can be used as a floating matter guidance control device that controls a vibration generating device that generates a water surface wave by vibrating a water surface.

### REFERENCE SIGNS LIST

1: floating matter guidance control device, 2: vibration generating device, 3: output device, 4: communication device, 5: measuring device, 10: water surface region identifying unit, 11: floating matter information obtaining unit, 12: installation location determining unit, 13: vibration determining unit, 14: vibration generating device control unit, 20: vibration generating unit, 21: vibration transfer plate, 22: speaker, 23: float, 30: vibration generating device, 40: floating matter guidance control device, 41: environmental information obtaining unit, 100: floating matter guidance system, 101: floating matter guidance system, 110: processing circuit, 111: vibration generating device, 112: output device, 113: processor, 114: memory, 115: processing circuit, 116: communication device, 117: processor, and 118: memory.

1. A floating matter guidance control device comprising:
processing circuitry
to obtain floating matter information about floating matter on a water surface;
to determine a frequency of vibration generated by a vibration generating device to generate a water surface wave by vibrating a water surface, on a basis of the obtained floating matter information; and
to control the vibration generating device so that the vibration generating device vibrates at the determined frequency.

2. The floating matter guidance control device according to claim 1, wherein the processing circuitry identifies a region of the water surface.

3. The floating matter guidance control device according to claim 2, wherein the processing circuitry determines an installation location of the vibration generating device on a basis of the identified region of the water surface.

4. The floating matter guidance control device according to claim 1, wherein
the vibration generating device includes a vibration transfer plate and a speaker as devices to generate the water surface wave, and
the processing circuitry switches a device to generate the water surface wave to one of the vibration transfer plate and the speaker.

5. The floating matter guidance control device according to claim 1, wherein the processing circuitry controls the vibration generating device so that the frequency of vibration generated by the vibration generating device changes temporally.

6. The floating matter guidance control device according to claim 1, wherein the processing circuitry determines a frequency of vibration generated by the vibration generating device, by performing a simulation of a water surface wave to be generated on the water surface, on a basis of the obtained floating matter information.

7. The floating matter guidance control device according to claim 6, wherein the processing circuitry obtains environmental information about an environment of the water surface, and
the processing circuitry determines a frequency of vibration generated by the vibration generating device, by performing a simulation of a water surface wave to be generated on the water surface, further on a basis of the obtained environmental information.

8. The floating matter guidance control device according to claim 7, wherein
the processing circuitry further obtains location information about a location of a measuring device at which the environmental information is obtained by measuring an environment of the water surface, and
when the processing circuitry determines, on a basis of the obtained location information, that the measuring device does not move toward a specific location, the processing circuitry changes the frequency of vibration generated by the vibration generating device.

9. A floating matter guidance system comprising:
the floating matter guidance control device according to claim 1; and
the vibration generating device.

10. The floating matter guidance system according to claim 9, further comprising a measuring device to measure environmental information about an environment of a water surface, wherein
the processing circuitry obtains the environmental information measured by the measuring device, and
the processing circuitry determines a frequency of vibration generated by the vibration generating device, by performing a simulation of a water surface wave to be generated on the water surface, further on a basis of the obtained environmental information.

11. A floating matter guidance control method comprising:
obtaining floating matter information about floating matter on a water surface;
determining a frequency of vibration generated by a vibration generating device to generate a water surface wave by vibrating a water surface, on a basis of the obtained floating matter information; and
controlling the vibration generating device so that the vibration generating device vibrates at the determined frequency.
